(19) United States
(12) Patent Application Publication
(10) Pub. No.: US 2025/0145536 A1
(43) Pub. Date: May 8, 2025

(54) CERAMIC MATERIAL, POWDER, AND LAYER SYSTEM COMPRISING THE CERAMIC MATERIAL

(71) Applicant: Siemens Energy Global GmbH & Co. KG, Munich (DE)

(72) Inventors: Arturo Flores Renteria, Berlin (DE); Dimitrios Zois, Berlin (DE)

(73) Assignee: Siemens Energy Global GmbH & Co. KG, Munich (DE)

(21) Appl. No.: 19/010,337

(22) Filed: Jan. 6, 2025

Related U.S. Application Data
(63) Continuation of application No. 17/770,821, filed on Apr. 21, 2022, now Pat. No. 12,187,652.

(30) Foreign Application Priority Data
Nov. 12, 2019 (DE) 10 2019 217 445.0

(51) Int. Cl. C04B 37/02; C04B 35/48; C04B 37/00

(52) U.S. Cl. CPC C04B 37/023; C04B 35/48; C04B 37/001; C04B 2235/3206; C04B 2235/3208; C04B 2235/3225; C04B 2235/3229; C04B 2235/3246; C04B 2237/121; C04B 2237/122; C04B 2237/123; C04B 2237/348; C04B 2237/40; C04B 2237/64

(57) ABSTRACT

An improved ceramic material for heat insulation with selection of specific stabilizers and adapted proportions, includes zirconium oxide with 0.2 wt. % to 8.0 wt. % of the base stabilizers: yttrium oxide (Y₂O₃), hafnium oxide (HfO₂), cerium oxide (CeO₂), calcium oxide (CaO), and/or magnesium oxide (MgO), wherein at least yttrium oxide (Y₂O₃) is used, and optionally at least one of the additional stabilizers: 0.2 wt. % to 20 wt. % of erbium oxide (Er₂O₃) and/or ytterbium oxide (Yb₂O₃).

### CROSS REFERENCE TO RELATED APPLICATIONS

This application is a continuation of U.S. patent application Ser. No. 17/770,821 filed Apr. 21, 2022 which is a US National Stage of International Application No. PCT/EP2020/057029 filed 18 Mar. 2020, and claims the benefit thereof. The International Application claims the benefit of German Application No. DE 10 2019 217 445.0 filed 12 Nov. 2019. All of the applications are incorporated by reference herein in their entirety.

### FIELD OF INVENTION

The invention relates to a ceramic material and to powder produced therewith that can be used for ceramic layer systems.

### BACKGROUND OF INVENTION

Ceramics in general have a high thermal stability and are therefore often used as ceramic coatings on high-temperature components, such as turbines, especially gas turbines.

The constant aim is to improve the heat insulation properties of the ceramic material.

### SUMMARY OF INVENTION

It is therefore an object of the invention to solve the problem identified above.

The object is achieved by means of a ceramic, a ceramic powder, and a system of layers as claimed.

Ceramic layers based on zirconium oxide with stabilizers are known; here, fully stabilized zirconium oxide is often used, owing to its better thermal stability.

The objective of the concept, however, is to use partially stabilized zirconium oxide having an improved stability, especially thermal stability.

### BRIEF DESCRIPTION OF THE DRAWINGS

FIGS. 1 to 4 show exemplary embodiments of the invention.

### DETAILED DESCRIPTION OF INVENTION

The zirconium oxide is stabilized with 0.2 wt % to 8 wt %, more particularly with 0.2 wt % to 6.0 wt %, of base stabilizers: yttrium oxide, hafnium oxide, cerium oxide, calcium oxide and/or magnesium oxide and optionally with additional stabilizers −0.2 wt % to 20 wt % of erbium oxide and/or ytterbium oxide.

Yttrium oxide is used in any case and at least one of the base stabilizers hafnium oxide, cerium oxide, calcium oxide and/or magnesium oxide is used.

This ceramic composition may be prepared as a powder, and so further additions, as in the use of abrasive layers, comprise cubic boron nitride or other abrasive particles.

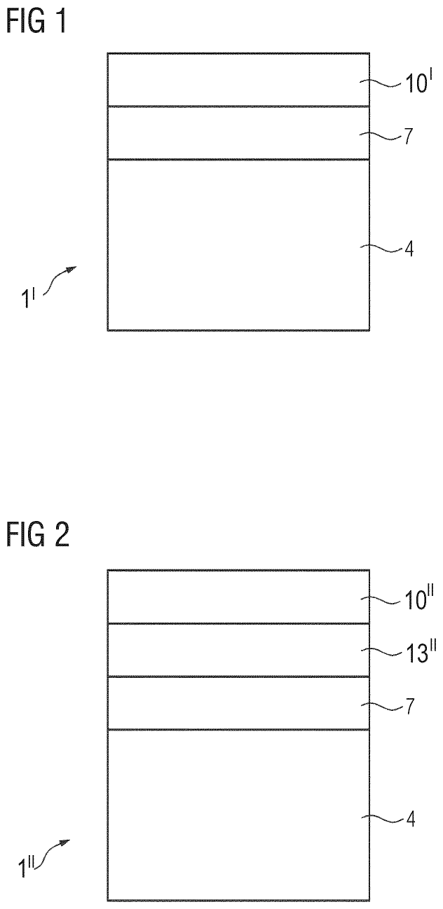

In a layer system 1^{I} (FIG. 1) a ceramic layer 10^{I} is applied to metal, the substrate 4 present, in the case of nickel- or cobalt-based superalloys used preferably, being a metallic adhesion layer 7 which forms aluminum oxide (TGO; not shown), with the metallic adhesion promoter layer constituting preferably an aluminide, platinum-aluminide or, as a basis, an NiCoCrAlY—X alloy, optionally with x=Ta, Re, Fe and/or Si.

The ceramic layer of the ceramic material in accordance with the invention may be produced by means of EB-PVD, plasma spraying (APS, etc.), etc. and has a columnar structure or a segmented structure.

The ceramic layers 10^{II}, 10^{III}, 10^{IV} (FIGS. 2-4) preferably have a layer thickness of 100 μm to 1000 μm.

As shown in FIG. 2, in a layer system 1^{II}, a ceramic layer 10^{II} as in FIG. 1 may also have a ceramic sublayer 13^{II}, the layer thickness of which, however, is at least 20% thinner in configuration than that of the ceramic material of the invention in the ceramic layer 10^{II}.

The ceramic sublayer 13^{II} preferably comprises 8YSZ, i.e., zirconium oxide stabilized with 3 mol % to 4 mol % of yttrium, and is therefore distinctly different from the material of the ceramic layer 10^{I}.

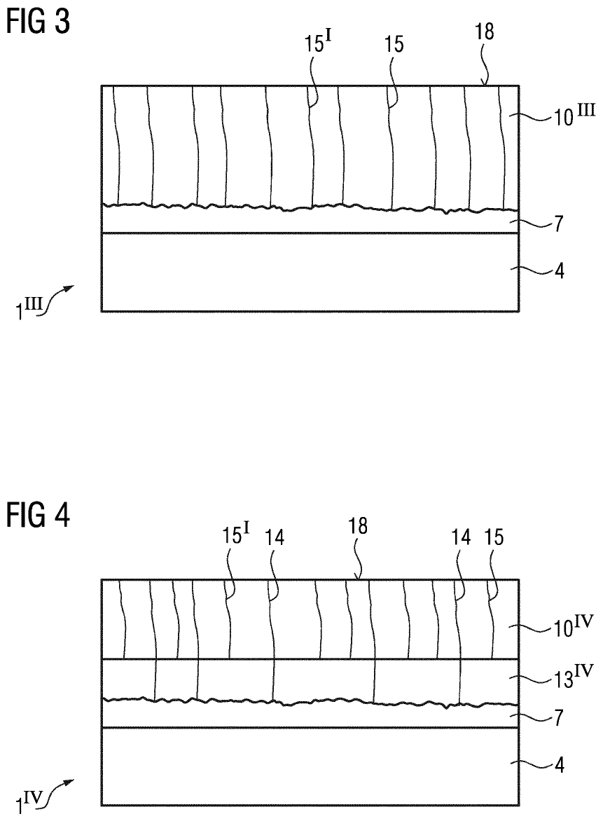

FIGS. 3 and 4 show further examples of layer structures 1^{III}, 1ªV of the invention.

According to FIG. 3, in comparison to FIG. 1, there is a segmented ceramic layer 10^{III} of a layer system 1^{III}, which comprises numerous, relatively long and vertical cracks 15, 15^{I}, starting from the surface 18 of the outermost ceramic layer 10^{III}, and extending very largely over the entire ceramic layer thickness, here in particular up to the metallic adhesion layer 7 or the TGO thereof (not shown).

A layer system 1^{IV} may also comprise a ceramic attachment layer 13^{IV} (FIG. 4) for attachment of the outermost layer 10^{IV} of a thermal barrier coating (TBC), in which case the attachment layer 13^{IV} may be configured as described in FIG. 2.

The outermost ceramic layer 10^{IV} is more particularly configured like the outermost layer 10^{III} in FIG. 3.

In the ceramic attachment layer 13^{IV}, however, cracks 14 extend, preferably likewise vertical, which extend through both ceramic layers 10^{IV}, 13^{IV}.

The relatively long cracks have been formed by specific process parameters or production methods, and do not represent cracks between multiple grains.

### Exemplary Embodiments

Zro₂+Y₂O₃+CeO₂

ZrO₂+Y₂O₃+MgO

ZrO₂+Y₂O₃+HfO₂

Zro₂+Y₂O₃+Cao

Zro₂+Y₂O₃+CeO₂+MgO

Zro₂+Y₂O₃+MgO+HfO₂

ZrO₂+Y₂O₃+HfO₂+CaO

Zro₂+Y₂O₃+CeO₂+HfO₂

Zro₂+Y₂O₃+MgO+CaO

ZrO₂+Y₂O₃+CeO₂+CaO

ZrO₂+Y₂O₃+CaO+CeO₂+HfO₂

Zro₂+Y₂O₃+HfO₂+MgO+CaO

ZrO₂+Y₂O₃+CeO₂+MgO+Cao

ZrO₂+Y₂O₃+CeO₂+MgO+HfO₂

Zro₂+Y₂O₃+HfO₂+CaO+CO₂+Mgo

Zro₂+Y₂O₃+CeO₂+Yb₂O₃

Zro₂+Y₂O₃+MgO+Yb₂O₃

Zro₂+Y₂O₃+HfO₂+Yb₂O₃ (particularly preferred)

ZrO₂+Y₂O₃+CaO+Yb₂O₃

Zro₂+Y₂O₃+CeO₂+MgO+Yb₂O₃

Zro₂+Y₂O₃+MgO+HfO₂+Yb₂O₃

Zro₂+Y₂O₃+HfO₂+CaO+Yb₂O₃

Zro₂+Y₂O₃+CeO₂+HfO₂+Yb₂O₃

Zro₂+Y₂O₃+MgO+CaO+Yb₂O₃

Zro₂+Y₂O₃+CeO₂+CaO+Yb₂O₃

ZrO₂+Y₂O₃+CaO+CeO₂+HfO₂+Yb₂O₃

Zro₂+Y₂O₃+HfO₂+MgO+CaO+Yb₂O₃

Zro₂+Y₂O₃+CeO₂+MgO+CaO+Yb₂O₃

ZrO₂+Y₂O₃+CeO₂+MgO+HfO₂+Yb₂O₃

Zro₂+Y₂O₃+HfO₂+CaO+CeO₂+MgO+Yb₂O₃

ZrO₂+Y₂O₃+CeO₂+Er₂O₃

ZrO₂+Y₂O₃+MgO+Er₂O₃

Zro₂+Y₂O₃+HfO₂+Er₂O₃

Zro₂+Y₂O₃+CaO+Er₂O₃

ZrO₂+Y₂O₃+CeO₂+MgO+Er₂O₃

Zro₂+Y₂O₃+MgO+HfO₂+Er₂O₃

Zro₂+Y₂O₃+HfO₂+CaO+Er₂O₃

ZrO₂+Y₂O₃+CeO₂+HfO₂+Er₂O₃

Zro₂+Y₂O₃+MgO+CaO+Er₂O₃

ZrO₂+Y₂O₃+CeO₂+CaO+Er₂O₃

Zro₂+Y₂O₃+CaO+CeO₂+HfO₂+Er₂O₃

Zro₂+Y₂O₃+HfO₂+MgO+CaO+Er₂O₃

ZrO₂+Y₂O₃+CeO₂+MgO+CaO+Er₂O₃

Zro₂+Y₂O₃+CeO₂+MgO+HfO₂+Er₂O₃

Zro₂+Y₂O₃+HfO₂+CaO+CO₂+MgO+Er₂O₃

Zro₂+Y₂O₃+CeO₂+Yb₂O₃+Er₂O₃

Zro₂+Y₂O₃+MgO+Yb₂O₃+Er₂O₃

Zro₂+Y₂O₃+HfO₂+Yb₂O₃+Er₂O₃ (particularly preferred)

Zro₂+Y₂O₃+CaO+Yb₂O₃+Er₂O₃

Zro₂+Y₂O₃+CeO₂+MgO+Yb₂O₃+Er₂O₃

Zro₂+Y₂O₃+MgO+HfO₂+Yb₂O₃+Er₂O₃

Zro₂+Y₂O₃+HfO₂+CaO+Yb₂O₃+Er₂O₃

Zro₂+Y₂O₃+CeO₂+HfO₂+Yb₂O₃+Er₂O₃

ZrO₂+Y₂O₃+MgO+CaO+Yb₂O₃+Er₂O₃

Zro₂+Y₂O₃+CeO₂+CaO+Yb₂O₃+Er₂O₃

Zro₂+Y₂O₃+CaO+CO₂+HfO₂+Yb₂O₃+Er₂O₃

Zro₂+Y₂O₃+HfO₂+MgO+CaO+Yb₂O₃+Er₂O₃

ZrO₂+Y₂O₃+CeO₂+MgO+CaO+Yb₂O₃+Er₂O₃

Zro₂+Y₂O₃+CeO₂+MgO+HfO₂+Yb₂O₃+Er₂O₃

Zro₂+Y₂O₃+HfO₂+CaO+CeO₂+MgO+Yb₂O₃+Er₂O₃

The ceramic material comprises preferably 2.5 wt % to 5.5 wt % of yttrium oxide (Y₂O₃), more particularly 3.0 wt % to 5.0 wt % of yttrium oxide (Y₂O₃), especially 3.5 wt % to 4.0 wt %.

The ceramic material may also comprise preferably 1.5 wt % to 3.0 wt % of yttrium oxide (Y₂O₃), more particularly 2.0 wt % to 2.5 wt % of yttrium oxide (Y₂O₃).

The ceramic material preferably comprises: hafnium oxide (HfO₂) at 0.2 wt % to 4.0 wt %, more particularly 0.5 wt % to 4.0 wt % of hafnium oxide (HfO₂), especially 0.6 wt % to 4.0 wt % of hafnium oxide (HfO₂).

For better, i.e., lower, thermal conductivity, the ceramic material preferably comprises: hafnium oxide (HfO₂) at 0.2 wt % to 2.0 wt %, more particularly at 0.6 wt % to 2.0 wt % of hafnium oxide (HfO₂), especially at 0.8 wt % to 2.0 wt % of hafnium oxide (HfO₂).

For better thermal stability the ceramic material preferably comprises: hafnium oxide (HfO₂) at 2.0 wt % to 4.0 wt %, more particularly 2.4 wt % to 4.0 wt % of hafnium oxide (HfO₂), especially 4.0 wt % to 4.0 wt % of hafnium oxide (HfO₂).

The ceramic material preferably comprises 5.5 wt % to 8.5 wt % of ytterbium oxide (Yb₂O₃), more particularly 6.0 wt % to 8.0 wt % of Yb₂O₃, especially 6.5 wt % to 7.5 wt % of Yb₂O₃.

The ceramic material comprises preferably 3.0 wt % to 4.5 wt % of ytterbium oxide (Yb₂O₃), more particularly 3.5 wt % to 4.0 wt % of ytterbium oxide (Yb₂O₃).

The ceramic material also preferably comprises 2.0 wt % to 4.0 wt % of Er₂O₃, more particularly 2.5 wt % to 3.5 wt % of Er₂O₃.

With further preference the ceramic material comprises (6.0-x) wt % of Y₂O₃ and between 2*x wt % and 4*x wt % of Yb₂O₃/Er₂O₃. For example, when x corresponds to 2, the ceramic material would comprise 4.0 wt % of Y₂O₃ and between 4 wt % and 8 wt %.

1. A ceramic material
based on zirconium oxide (Zro₂)
with 0.2 wt % to 8.0 wt % of base stabilizers:
more particularly with 0.2 wt % to 6.0 wt % of base stabilizers:
yttrium oxide (Y₂O₃), hafnium oxide (HfO₂), cerium oxide (CeO₂), calcium oxide (CaO) and/or magnesium oxide (MgO),
wherein at least yttrium oxide (Y₂O₃) is used, and optionally
at least one of the additional stabilizers:
0.2 wt % to 20 wt % of erbium oxide (Er₂O₃) and/or ytterbium oxide (Yb₂O₃).

2. The ceramic material as claimed in claim 1, comprising
at least 0.5 wt % and not more than 6.0 wt % of yttrium oxide (Y₂O₃).

3. The ceramic material as claimed in claim 1, comprising
1.5 wt % to 3.0 wt % of yttrium oxide (Y₂O₃),
more particularly 2.0 wt % to 2.5 wt % of yttrium oxide (Y₂O₃).

4. The ceramic material as claimed in claim 1, which comprises
at least yttrium oxide (Y₂O₃) and hafnium oxide (HfO₂) as base stabilizers,
more particularly comprises only yttrium oxide (Y₂O₃) and hafnium oxide (HfO₂) as base stabilizers.

5. The ceramic material as claimed in claim 1,
in which the hafnium oxide (HfO₂) content is 0.2 wt % to 4.0 wt %,
more particularly 0.6 wt % to 4.0 wt % of hafnium oxide (HfO₂),
especially 0.8 wt % to 4.0 wt % of hafnium oxide (HfO₂).

6. The ceramic material as claimed in claim 1, which comprises
at least one of the additional stabilizers erbium oxide (Er₂O₃) and/or ytterbium oxide (Yb₂O₃).

7. The ceramic material as claimed in claim 1, comprising, more particularly consisting of, ZrO₂—HfO₂—Y₂O₃—Yb₂O₃.

8. The ceramic material as claimed in claim 1, comprising, more particularly consisting of, ZrO₂—HfO₂—Y₂O₃—Yb₂O₃—Er₂O₃.

9. The ceramic material as claimed in claim 1, comprising
3.0 wt % to 4.5 wt % of ytterbium oxide (Yb₂O₃),
more particularly 3.5 wt % to 4.0 wt % of ytterbium oxide (Yb₂O₃).

10. The ceramic material as claimed in claim 1, comprising
2.0 wt % to 4.0 wt % of erbium oxide (Er₂O₃),
more particularly 2.5 wt % to 3.5 wt % of erbium oxide (Er₂O₃).

11. The ceramic material as claimed in claim 1, comprising
(8.0-x) wt % of Y₂O₃+ (2-4) x wt % of Yb₂O₃/Er₂O₃,
more particularly (6.0-x) wt % of Y₂O₃+ (2-4) x wt % of Yb₂O₃/Er₂O₃.

12. The ceramic material as claimed in claim 1,
in which the hafnium oxide (HfO₂) content is 0.2 wt % to 2.0 wt %,
more particularly 0.6 wt % to 2.0 wt % of hafnium oxide (HfO₂),
especially 0.8 wt % to 2.0 wt % of hafnium oxide (HfO₂).

13. The ceramic material as claimed in claim 1,
in which the hafnium oxide (HfO₂) content is 2.0 wt % to 4.0 wt %,
more particularly 2.4 wt % to 4.0 wt % of hafnium oxide (HfO₂),
especially 3.0 wt % to 4.0 wt % of hafnium oxide (HfO₂).

14. A ceramic powder comprising,
more particularly consisting of,
a composition of a material as claimed in claim 1.

15. A system (1) of layers at least comprising
a metallic substrate (4),
optionally a metallic adhesion promoter layer (7), and an at least one ceramic layer (10¹, 10^{II}, 10^{III}, 10^{IV}) based on the material of the invention as claimed in claim 1.

16. The layer system as claimed in claim 15, comprising
a metallic adhesion promoter layer (7) between the ceramic layer (13^{II}, 13^{IV}; 10^{I}, 10^{III}) and the metallic substrate (4),
more particularly directly on the substrate (4),
wherein the adhesion promoter layer (7) comprises an alloy of the type NiCoCrAlY—X, X being optionally=Ta, Re and/or Si, more particularly NiCoCrAlY or NiCoCrAlY—Ta.

17. The layer system as claimed in claim 15,
in which a ceramic sublayer (13^{II}, 13^{IV}) is present below the ceramic layer (10^{II}, 10^{IV}),
which more particularly is at least 20% thinner in configuration and comprises
yttrium-stabilized zirconium oxide (YSZ),
more particularly 8YSZ,
i.e., zirconium oxide stabilized with 3 mol % to 4 mol % of yttrium.

18. The layer system as claimed in claim 15, which comprises a segmentation,
more particularly by means of relatively long vertical cracks (14; 15, 15^{I}),
in the one or more ceramic layers (10^{III}, 10^{IV}; 13^{IV}),
more particularly also in the ceramic sublayer (13^{IV}).

19. The layer system as claimed in claim 18,
in which the segmentation is present by means of vertical cracks (15, 15^{I}) only in the outermost ceramic layer (10^{III}, 10^{IV}).

20. The layer system as claimed in claim 18,
in which the segmentation runs by means of vertical cracks (14) through both ceramic layers (10^{IV}; 13^{IV}).
